(19) United States
(12) Patent Application Publication
(10) Pub. No.: US 2008/0289357 A1
(43) Pub. Date: Nov. 27, 2008

(54) LIQUID NITROGEN COOLED BEVERAGE DISPENSER

(76) Inventors: Robert M. Skobel, Rockwall, TX (US); Daniel Davey, Virginia Beach, VA (US)

Correspondence Address: MICHAEL A. O'NEIL, P.C., 5949 SHERRY LANE, SUITE 820, DALLAS, TX, 75225, US

(21) Appl. No.: 12/123,794

(22) Filed: May 20, 2008

Related U.S. Application Data
(60) Provisional application No. 60/939,417, filed on May 22, 2007.

(51) Int. Cl. B67D 5/62

(52) U.S. Cl. 62/386; 222/146.6

(57) ABSTRACT

Liquids to be dispensed as “frozen” or “slush” beverages are rapidly cooled to a suitable target viscosity or percentage of frozen, by maintaining a flow of liquid nitrogen through one or more heat exchangers, counterflowing the beverage to be cooled from a reservoir to a dispenser, and controlling the flow of liquid nitrogen to achieve the target viscosity or percentage of frozen of the beverage to be dispensed.

### CLAIM OF PRIORITY

Applicants claims priority based on Provisional Patent Application Ser. No. 60/939,417 filed May 22, 2007, the entire contents of which are incorporated herein by reference.

### DESCRIPTION OF THE DRAWINGS

FIG. 1 is a perspective view, shown partially in phantom, of a cooling unit with a series of shell and coil heat exchange elements providing heat transfer between a beverage and a cryogen;

FIG. 2 is a perspective view, shown partially in phantom, of a cooling unit with an alternative embodiment of a series of shell and coil heat exchange elements providing heat transfer between a beverage and a cryogen;

FIG. 3 is a perspective view, shown partially in phantom, of a cooling unit with a shell and coil heat exchange element and a co-annular coil heat exchange element providing heat transfer between a beverage and cold gases;

FIG. 4 is an expanded view of a shell and coil heat exchange element;

FIG. 5 is an expanded perspective view, shown partially in phantom, of a shell and coil heat exchange element incorporating flow control means;

FIG. 6 is a perspective view, shown partially in phantom, of a cooling unit comprising a shell and coil heat exchange element and a series of shell and coil heat exchange elements providing heat transfer between a beverage and a cryogen;

FIG. 7 is a perspective view, shown partially in phantom, of another embodiment of a cooling unit;

FIG. 8 is a perspective view, shown partially in phantom, of yet another embodiment of a cooling unit; and

FIG. 9 is a perspective view, shown partially in phantom, of yet another embodiment of a cooling unit.

### DETAILED DESCRIPTION

Many beverages are preferably consumed cold. Some beverages such as “frozen” margaritas and “slush” beverages are consumed in a semi-frozen state (also referred to as a percentage of frozen). High volume sales opportunities for “frozen” margaritas and “slush” beverages exist in locations such as sports and concert venues, bars, and restaurants.

In order to satisfy the consumer demand for cold beverages, “frozen” margaritas, and other “slush” beverages, numerous methods and devices for refrigeration have heretofore been developed. Prior art refrigeration systems are not capable of providing adequate refrigeration at a high enough capacity so as to allow the rapid “freezing” of large volumes of beverage.

Utilization of an embodiment of the present invention eliminates several limiting factors associated with the prior art so as to achieve higher production capacity. Embodiments of the present invention utilize open-cycle refrigeration whereby a cryogen is used as a cooling agent to cool a beverage. The cryogen is then released directly to the atmosphere after absorbing the heat from the beverage. Prior art refrigeration systems require the refrigerant (cooling agent) to be re-compressed upon heat exchange and additionally require absorbed heat to be released to the atmosphere via a heat exchanger. By employing open-cycle refrigeration the capacity of the cooling system is only limited by the amount of cryogen available and the rate of heat transfer from the beverage being cooled. In addition the cryogen provides much colder temperatures so as to rapidly “freeze” large volumes of a beverage to be served.

The physical properties of nitrogen make it an ideal fluid for transferring heat in that nitrogen in its liquid state is much colder (−320° F.) than the temperatures typically seen in closed-cycle refrigeration. This in turn allows the rapid cooling of large quantities of a “frozen” beverage. This is desirable, especially in high volume sales situations, as discussed above, as more beverages can be sold in a shorter time period, resulting in increased sales and profits.

Further, nitrogen and other such substances are highly compressible, allowing a large amount of cryogen to be stored in a small container, and thus easily transported, etc. Another advantage of using nitrogen, or similar substances, is that excess/used gas can be vented directly to the atmosphere, eliminating environmental and containment concerns associated with the prior art.

One embodiment of the present invention provides a beverage dispenser for rapidly and efficiently cooling a beverage to a “frozen” state and delivering the beverage to a consumer. This embodiment of the invention comprises an apparatus for cooling a beverage and dispensing the beverage at a percentage of frozen or desired viscosity, utilizing liquid nitrogen or a similar cryogen as a cooling agent, and comprises a beverage dispenser having one or more heat exchange elements for exchanging heat between the cryogen and a beverage. Cryogen is supplied to the heat exchange element(s) from a reservoir. Cryogen flow is controlled by one or more sensors and an associated controller. The controller is adapted to receive inputs from the one or more sensors and a plurality of operator inputs. The controller is further adapted to selectively control the operation of a pump, so as to effect beverage flow, and a plurality of flow control devices including at least one valve adapted to control cryogen flow through the heat exchange element(s).

The beverage to be served is supplied from a reservoir from which it is pumped or otherwise supplied to the heat exchange elements(s). As discussed above, the beverage is cooled by heat transfer from the beverage to the heat exchange element(s). The cooled beverage is then dispensed. Excess/used cryogen can be safely vented to the atmosphere. This is particularly true in the case of nitrogen which, as is well known, comprises approximately 78% of the atmosphere.

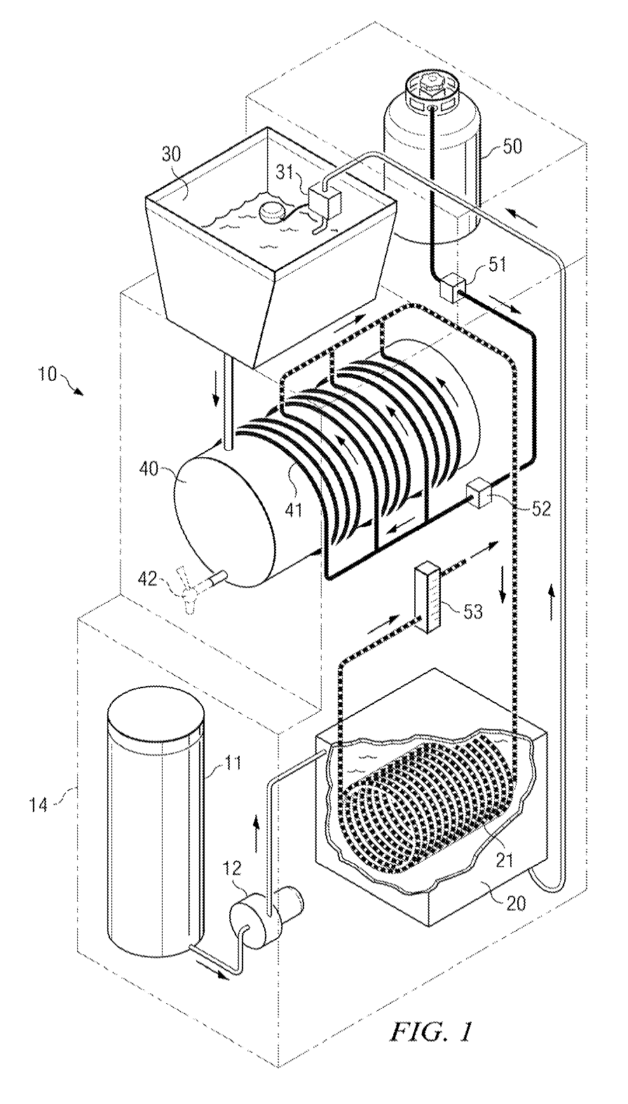

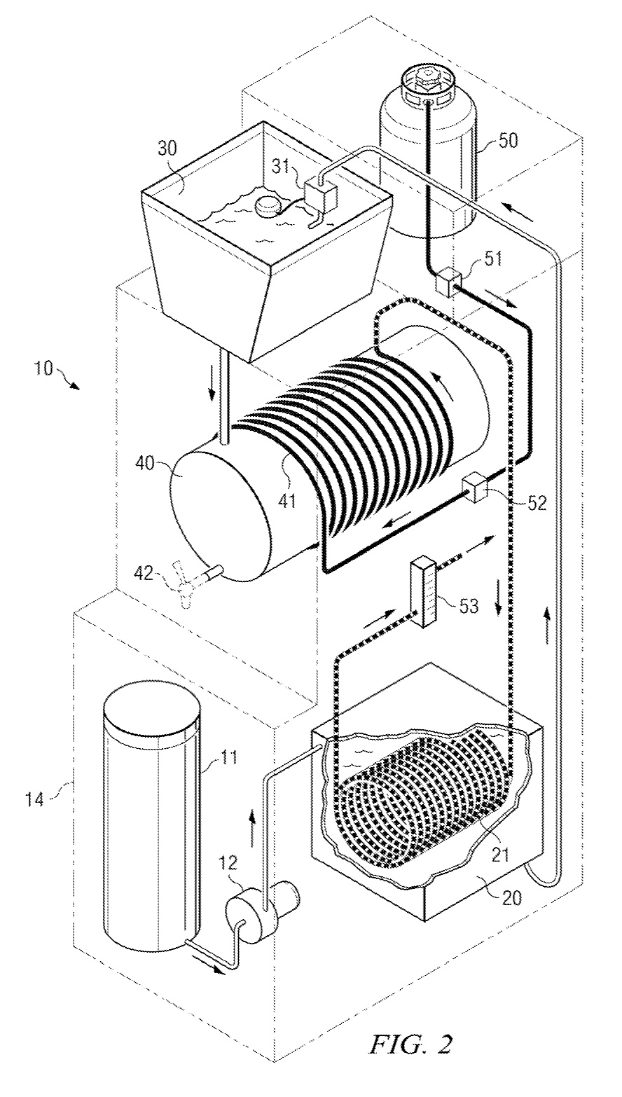

Referring to FIGS. 1-3, there is shown a beverage dispenser 10 constructed in accordance with an embodiment of the present invention. Specifically referring to FIGS. 1 and 2, the beverage dispenser 10 is comprised of a beverage mix reservoir 11 that holds a pre-mixed beverage prior to the cooling cycle. A housing 14 encloses the beverage dispenser 10.

A pump 12 moves the beverage to a heat exchange element 20 wherein the beverage loses heat to a cryogen in the coils 21 of the heat exchange element 20. The beverage is then pumped to a beverage reservoir 30 wherein the level in the reservoir 30 is maintained by a control device 31. From the reservoir 30, the beverage flows to a dispensing reservoir 40 wherein the beverage loses heat to cryogen in coils 41 surrounding the dispensing reservoir 40. The beverage is dispensed through a nozzle 42.

A cryogen such as liquid nitrogen flows from a cryogen supply 50 through a cryogen monitor 51 and a control device 52 to the coils 41 surrounding the dispensing reservoir 40 wherein the cryogen collects heat from the beverage in the dispensing reservoir 40. Other cryogens can also be utilized, such as inert gases having boiling points below −100° C., e.g. argon, helium, or neon.

Disposed within the dispensing reservoir 40 is a scraping component which rotates about the inner wall of the dispensing reservoir 40 so as to scrape off beverage that becomes frozen on the inner wall of the dispensing reservoir 40. This step is done to achieve desired heat transfer rates and for the purpose of maintaining a homogenous product. In addition, scraping blades are monitored for a desired viscosity and send a signal to control device 52 to adjust when necessary to achieve the correct viscosity or percentage of frozen.

Cold gas resulting from evaporation of the liquid cryogen flows to the coils 21 of the heat exchange element 20 wherein the cold gas collects heat from the beverage in the heat exchange element 20. The flow of cold gas from the coils 21 of the heat exchange element 20 is monitored and regulated by a flow control device, preferably a flow meter and flow control valve 53. The dispensing reservoir 40/coils 41 of the embodiment of FIG. 1 is a three-pass tube/one-pass shell heat exchanger.

Referring to FIG. 2, the dispensing reservoir 40/coils 41 is a one-pass tube/one-pass shell heat exchanger.

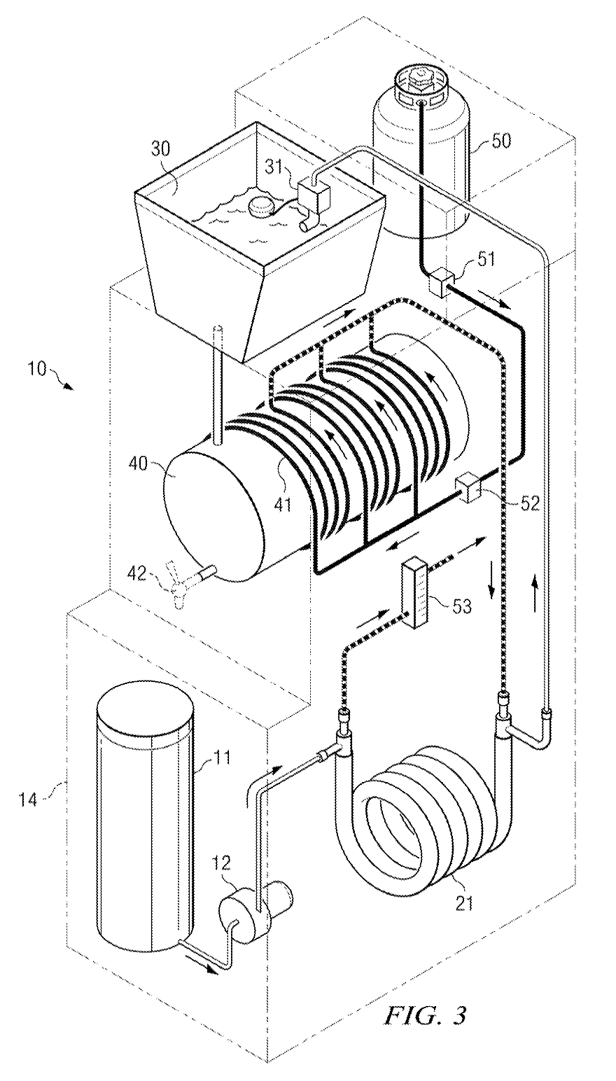

Referring to FIG. 3, the heat exchange element 21′ is a co-annular counter-flow heat exchanger.

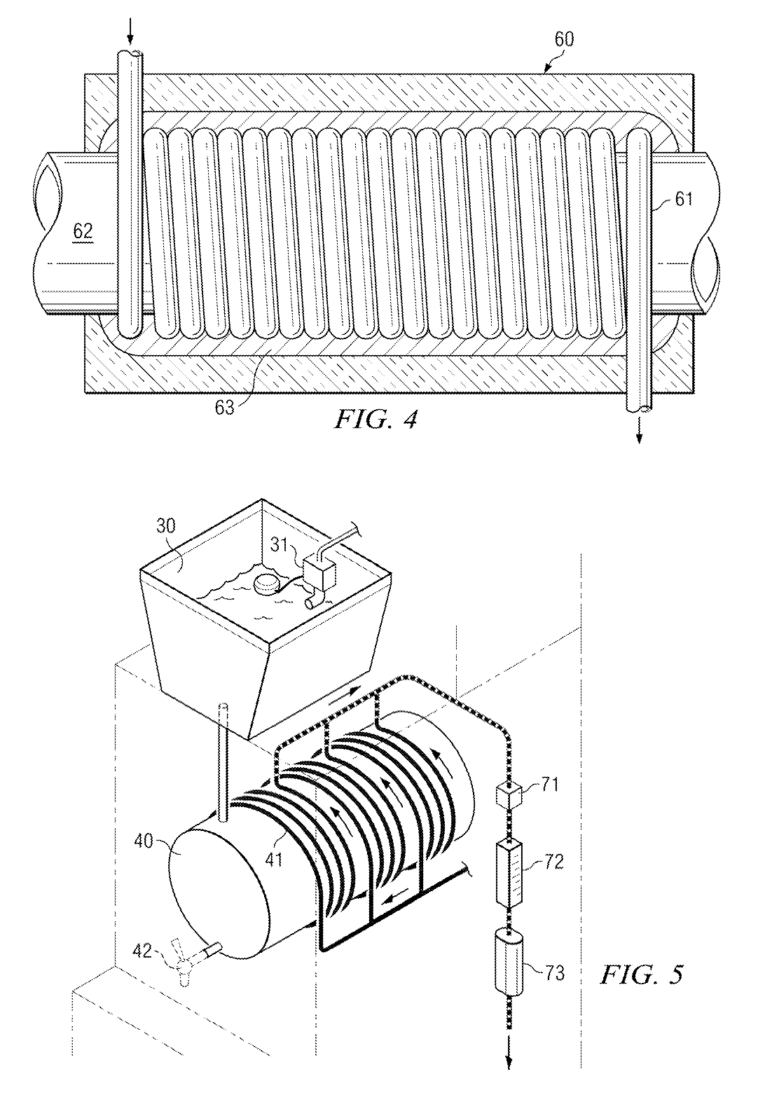

Referring to FIG. 4, a heat exchanger 60 suitable for use with an embodiment of the invention is shown. A coil 61 surrounds a tube 62. An aluminum layer 63 facilitates heat transfer.

Referring to FIG. 5, the utilization of a valve 71, a flow control meter 72, and an exhaust noise reducer 73 for control of the flow of cryogen are shown.

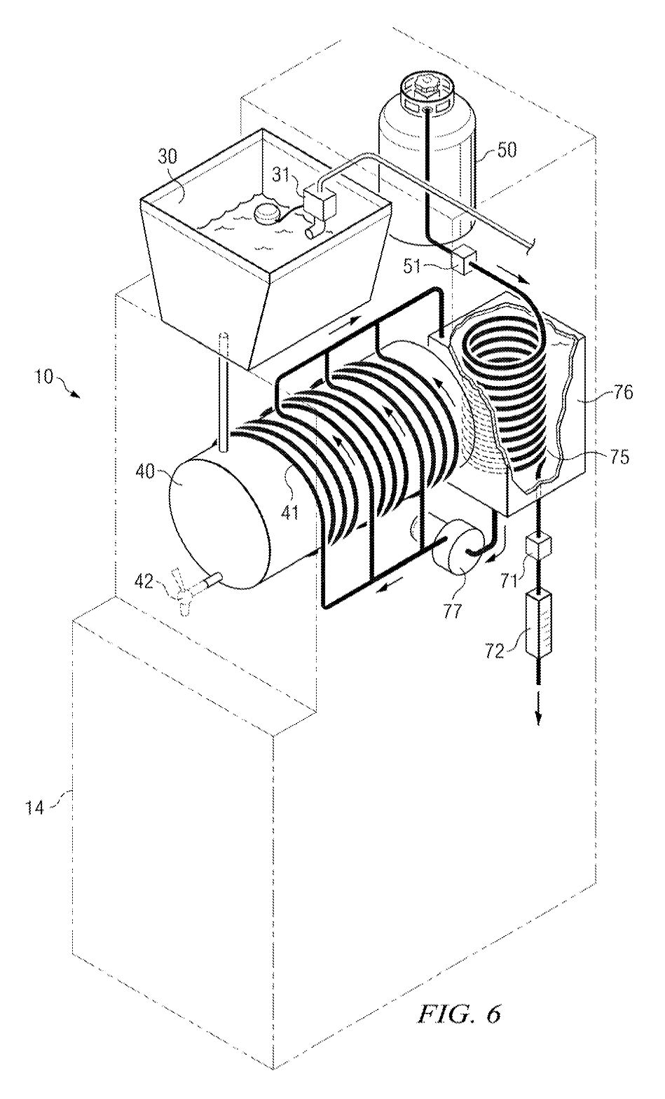

Referring to FIG. 6, a cryogen, for example, liquid nitrogen, is withdrawn from the container 50 and is directed through a coil 75 situated within a container 76. In this embodiment, the coil 75 in the container 76 comprises a one pass tube/one pass shell heat exchanger. After passing through the coil 75, the cryogen is directed through a valve 71 and a flow control meter 72 and is eventually discharged into the atmosphere.

A pump 77 withdraws a heat transfer fluid, typically glycol, from the container 76 and directs the heat transfer fluid through a throughpass tube/one pass shell heat exchanger 41 which removes heat from the beverage contained in the dispensing reservoir 40. After passing through the coils comprising the heat exchanger 41, the heat transfer fluid is returned to the container 76.

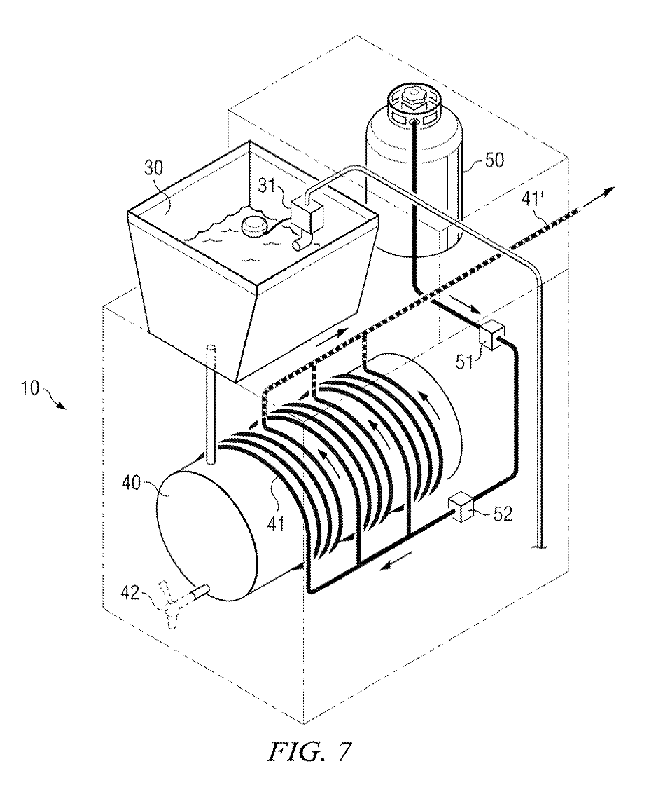

Referring to FIG. 7, the beverage dispenser 10 is similar to the embodiment illustrated in FIG. 1, except that heat exchanger 41′ passes out of a back wall of the beverage dispenser 10 in order to vent out the excess/used cryogen safely into the atmosphere.

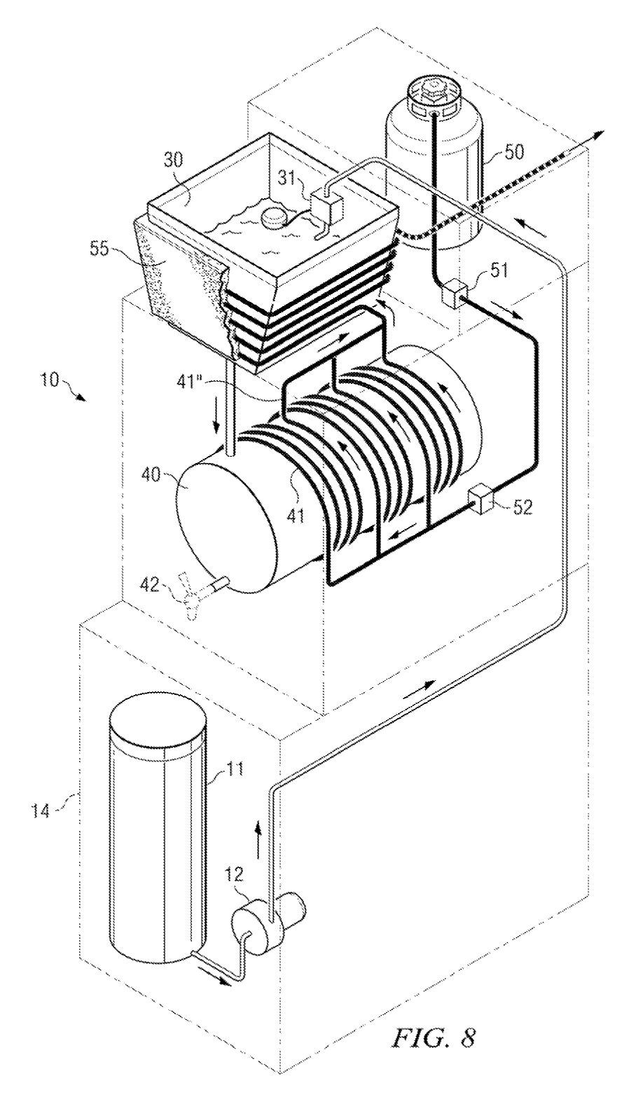

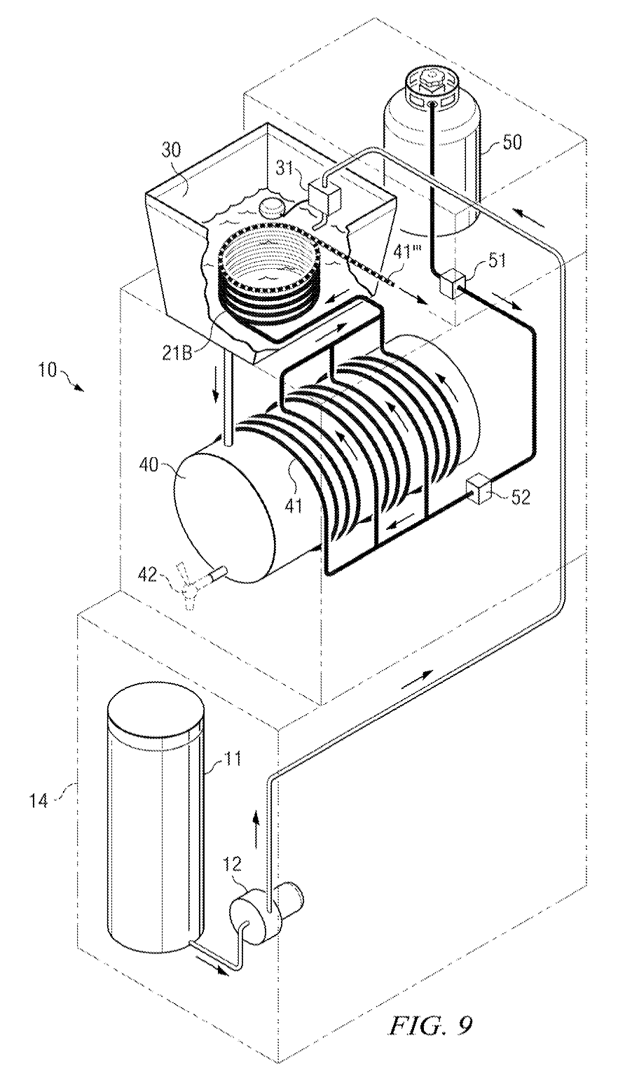

Referring to FIG. 8, the beverage dispenser 10 is illustrated in another embodiment. In this embodiment, the heat exchanger 41″ wraps around the beverage reservoir 30 and then passes out the back wall of the beverage dispenser 10 in order to vent out the excess/used cryogen safely into the atmosphere. In addition, the beverage reservoir 30 has an insulating wrap 55 that covers the portion of the heat exchanger 41″ that is wrapped around the beverage reservoir 30.

Referring to FIG. 9, the beverage dispenser 10 is illustrated in yet another embodiment. In this embodiment, the heat exchanger 41′″ is coiled within the beverage reservoir 30 and then passes out a side wall of the beverage reservoir 30 in order to vent out the excess/used cryogen safely into the atmosphere.

Although preferred embodiments of the invention have been illustrated in the accompanying Drawings and described in the foregoing Summary and Detailed Description, it will be understood that the invention is not limited to the embodiments disclosed, but is capable of numerous rearrangements, modifications, and substitutions of parts and elements without departing from the spirit of the invention.

1. A beverage dispensing system comprising:
a container for receiving and dispensing a beverage;
a heat exchange device supported on and at least partially surrounding the container; and
a controller for adjusting the flow of an initially liquid cryogen through the heat exchange device and there by substantially cooling the beverage.

2. The system of claim 1 further including at least one sensor within the container and means responsive to the sensor for controlling flow rate of the cryogen.

3. The system of claim 1 further comprising:
a first beverage reservoir;
a heat exchange element for receiving beverage mix from the first beverage reservoir and for first removing heat from the beverage mix;
a second beverage reservoir connected to the heat exchange element for receiving beverage mix from the heat exchange element; and
a second heat exchange coil supported on and at least partially surrounding the second beverages reservoir for removing residual heat from the beverage.

4. A beverage dispensing system comprising:
a beverage reservoir container, wherein the beverage reservoir container holds a beverage;
a dispensing reservoir that receives beverage from the beverage reservoir and selectively dispenses the beverage;
a tank containing a cryogen;
a heat exchanger connected to the tank, wherein the cryogen flows through the heat exchanger and wherein the heat exchanger is supported on and at least partially surrounding the dispensing reservoir;
at least one sensor within the dispensing reservoir that senses the viscosity of the beverage; and
at least one controller that adjusts the flow of the cryogen through the heat exchanger according to the at least one sensor to achieve a desired percentage of frozen of the beverage.

6. The system of claim 4 wherein an amount of used/excess cryogen vents to the atmosphere.

7. The system of claim 4 wherein the cryogen is selected from the group consisting of: nitrogen, argon, helium, and neon.

8. A beverage dispensing system comprising:
a beverage reservoir container a beverage;
a dispensing reservoir that receives beverage from the beverage reservoir and selectively dispenses the beverage;
a tank containing a cryogen, wherein the cryogen is selected from the group consisting of: nitrogen, argon, helium, and neon;
a heat exchanger connected to the tank, wherein the cryogen flows through the heat exchanger and wherein the heat exchanger is supported on and at least partially surrounding the dispensing reservoir, and wherein the cryogen vents out to the atmosphere after flowing through the heat exchanger;
at least one sensor within the dispensing reservoir for monitoring the viscosity of the beverage and for generating a corresponding output; and
at least one controller for adjusting the flow of the cryogen through the heat exchanger responsive to the output of the sensor.
